(19) United States
(12) Patent Application Publication
(10) Pub. No.: US 2026/0127297 A1
(43) Pub. Date: May 7, 2026

(54) METHOD AND SYSTEM FOR SECURING A COMPUTER FILE

(71) Applicant: Munro Design & Technologies, LLC, Ontario, NY (US)

(72) Inventor: James F. MUNRO, Ontario, NY (US)

(21) Appl. No.: 19/379,254

(22) Filed: Nov. 4, 2025

Related U.S. Application Data
(60) Provisional application No. 63/715,971, filed on Nov. 4, 2024.

(51) Int. Cl. G06F 21/60

(52) U.S. Cl. CPC G06F 21/602

(57) ABSTRACT

A method for securing one or more computer files includes obtaining at a computer device having a file and at a handset device data based on movement of at least one of the devices with the respect to the other device and generating an encryption key based on the obtained data at each of the devices wherein the key at each of the devices is substantially the same, and encrypting the file on the computer with the encryption key, discarding the computer encryption key and saving the handset encryption key. Later, the encryption key saved on the handset can be used to decrypt the encrypted file. Further, the method can be used to secure a plurality of files with the generated encryption key.

### CROSS-REFERENCE TO RELATED APPLICATION

This patent application claims the benefit of U.S. Provisional Application Ser. No. 63/715,971, filed Nov. 4, 2024, the disclosure of which is incorporated by reference herein in its entirety as part of the present application.

### FIELD

This technology generally relates to methods for cryptographically securing a file on a computer and, more particularly, to a method for encrypting a computer file with a key that is generated with the motion of a handset wherein the encryption key is also stored on the handset and wherein the stored encryption key is subsequently used to decrypt the file.

### BACKGROUND

The theft of computer data by adversarial entities is at an all-time high. These thefts generally occur through the internet and entail the downloading of targeted computer files which are then opened and the contents of the data inspected and used for malicious purposes. Further, the theft of computer files is expected to worsen when encryption keys generated by public key cryptographic methods are broken in the near future when quantum computers become available. One solution to the computer file theft file problem is to encrypt the computer files on the computer with an algorithm that does not rely on public key cryptography. Ideally, the implementation of this solution should be user-friendly and not utilize the internet.

### SUMMARY

A method for securing a file on a computing device includes generating, by the computing device, an encryption key at the computing device having a file based on obtained movement data of at least one of the computing device with the respect to another computing device. The another computing device has the encryption key separately generated based on the obtained movement data and the encryption key at the computing device and the another computing device is substantially the same. The file on the computing device is encrypted, by the computing device, with the encryption key. The encryption key at the computing device is discarded, by the computing device, with the encryption key saved on the another computing device.

A non-transitory machine readable medium having stored thereon instructions comprising executable code that, when executed by one or more processors, causes the processors to generate an encryption key at a computing device having a file based on obtained movement data of at least one of the computing device with the respect to another computing device. The another computing device has the encryption key separately generated based on the obtained movement data and the encryption key at the computing device and the another computing device is substantially the same. The file on the computing device is encrypted, by the computing device, with the encryption key. The encryption key at the computing device is discarded, by the computing device, with the encryption key saved on the another computing device.

A system device comprising one or more computing devices each comprising memory having programmed instructions stored thereon and one or more processors configured to execute the stored programmed instructions to generate an encryption key at a computing device having a file based on obtained movement data of at least one of the computing device with the respect to another computing device. The another computing device has the encryption key separately generated based on the obtained movement data and the encryption key at the computing device and the another computing device is substantially the same. The file on the computing device is encrypted, by the computing device, with the encryption key. The encryption key at the computing device is discarded, by the computing device, with the encryption key saved on the another computing device.

A system for securing one or more computer files in accordance with examples of this technology includes generating an identical shared secret symmetric key at a computer and a handset based on movement of at least one of the devices with the respect to the other device. The key at the computer is used by software executing on the computer to encrypt the computer file, after which the key on the computer and any clear-text copies of the encrypted computer file are wiped from the computer. The identical key at the handset is saved on the handset to be used later for decrypting the encrypted file on the computer.

To decrypt the encrypted computer file in accordance with examples of this technology, a second identical shared secret symmetric key is again generated at the computer and a handset based on movement of at least one of the devices with the respect to the other device. Software executing on the handset then encrypts the saved file encryption key with the second key and transmits the encrypted key to the computer. Software executing on the computer then decrypts the received encrypted file key and decrypts it with its copy of the second key. The computer software now has possession of the file encryption key and uses it to decrypt the encrypted computer file. After the file is decrypted, all keys generated in the encryption/decryption process can be discarded.

Accordingly, examples of this technology provide a system and method for generating symmetric secret keys that are used to encrypt one or more computer files with the use of another computing device, such as a handset or mobile phone by way of example, and securely storing the generated secret key on the another computing to be used later for decrypting the encrypted computer file. Examples of this technology advantageously discard the encryption key which is saved on another computing device separately from where the file is stored until needed later. Examples of this technology also advantageously utilize a unique approach for generating the encryption keys in real time based on the obtained movement data to store with a first encryption key generated securely in real time and then separately retrieve with a second encryption key generated securely in real time. Further, examples of this technology are not susceptible to being broke by quantum computers when they become available as illustrated and described by way of the examples herein.

### BRIEF DESCRIPTION OF THE DRAWINGS

FIG. 1 is a block diagram of a system for securing a computer file in accordance with examples of this technology;

FIG. 2 is a flowchart of the process for encrypting a computer file in accordance with examples of this technology;

FIG. 3 is a flowchart of the process for decrypting a computer file in accordance with examples of this technology;

### DETAILED DESCRIPTION

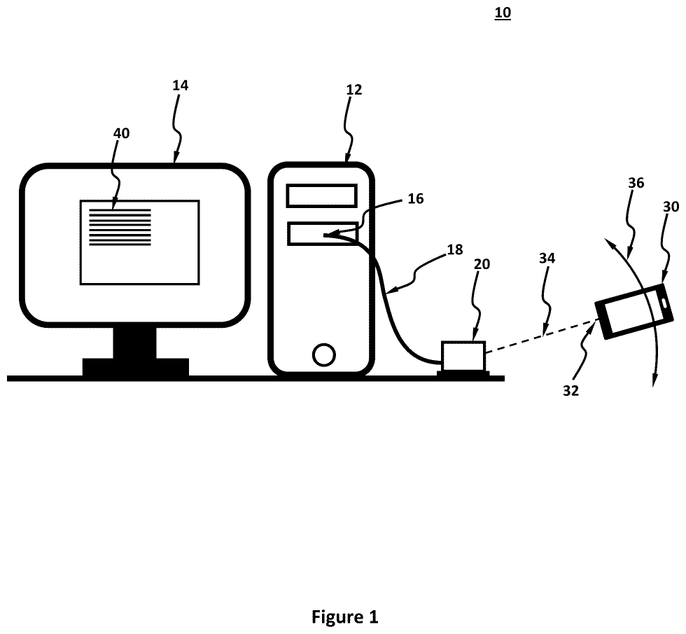

An exemplary system for securing one or more computer files 10, as shown in FIG. 1, can comprise a computer 12 having one or more computer files that need to be encrypted, decrypted, or otherwise secured, coupled to a monitor 14 which displays a list 40 of one or more computer files residing on computer 12 to a user. Computer 12 can also have a communication port 16 coupled to a communication cable 18, which in turn is coupled to a computer transceiver 20, although other configurations are possible as well, such as one in which a transceiver 20 is built into computer 12 and the port 16 and cable 18 are not needed in this example. System 10 also can include a mobile device or handset 30 having a handset transceiver 32 that transmits and receives signals 34 to and from computer transceiver 20. To generate secret key bits as described in examples below, the handset is waved, swiped, or otherwise moved about computer transceiver 20 as described below.

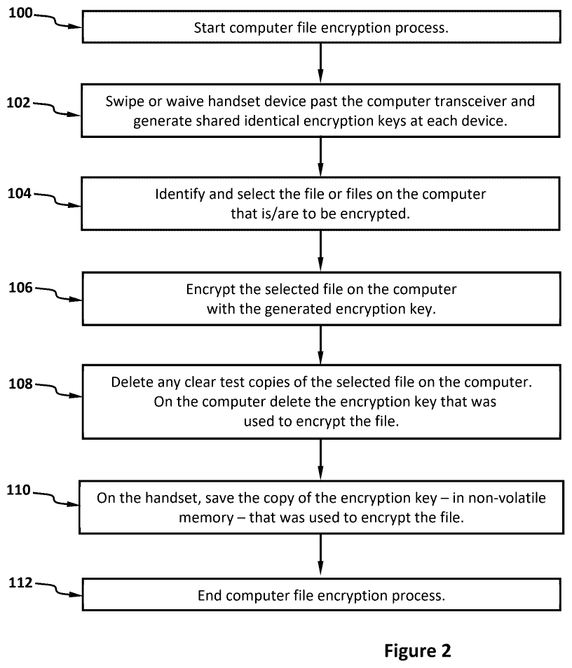

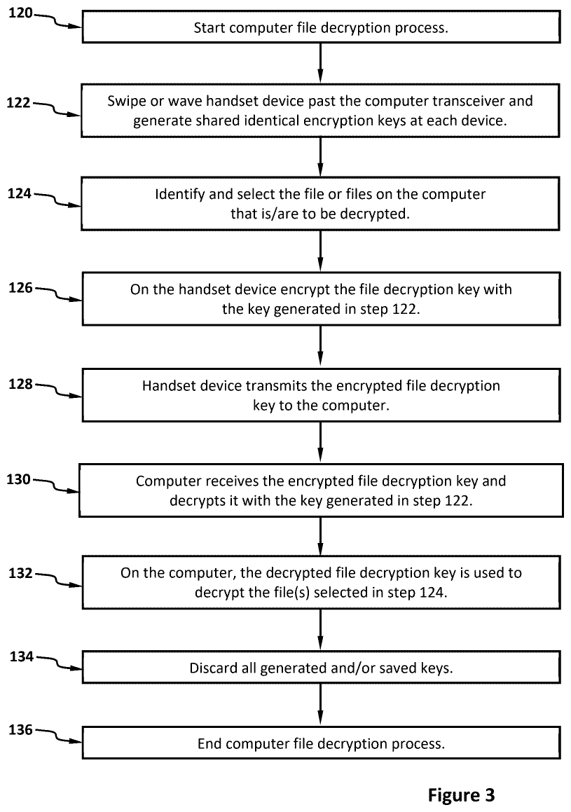

Computer 12 can be a personal computer, laptop computer, workstation computer, tablet computer, a mobile or handset computer, or any computing device having a processing system and memory, such as disk memory, flash, or random-access-memory, in which a digital file resides that is to be secured. Computer 12 can execute with benefit of the Windows, ChromeOS, Linux, Unix, iOS, macOS, Android, or other operating system, under which encryption program or other encryption software stored in the memory executes programmed instructions stored in the memory for performing the file encryption and decryption processes described below in connection with exemplary FIGS. 2 and 3.

Monitor 14 can be a display, such as an LCD, LED, or OLED display device by way of example, coupled to computer 12 and used to display computer information to a user, the displayed computer information being under the control of the operating system and/or the software executing the file encryption and decryption processes described below in connection with FIGS. 2 and 3. The computer information being displayed by monitor 14 under the control of the operating system and/or the software executing the file encryption and decryption processes can be a file or list of files 40 that are to be identified and selected for encryption or decryption. Included with the displayed names of the files in the list of files 40 can be metadata, such as the file's creation date(s), the type of file(s), and data indicating whether the file is currently encrypted or not encrypted, and if it is encrypted then additional meta data can be displayed regarding the file's date of encryption and the identity of the device, e.g., the identity of handset 30, which has possession of the key for decrypting the encrypted file by way of example.

Communication port 16 can be a parallel or a serial communication port such as a USB (Universal Serial Bus) port which is commonly used for communicating with peripheral devices such as computer transceiver 20. Communication port 16 can also be an ethernet port, PS2, lightning, firewire, IEEE-1394, RS-232, RS-422, RS-485, or other type of serial port, or port 16 can be a wireless port although a wireless port (e.g., infrared, Wif-fi, Bluetooth, etc.) is sub-optimal as the wireless signals may be susceptible to eavesdropping.

Digital signals and information, again under the control of the operating system and/or the software executing the file encryption and decryption processes, are sent through communication cable 18 to and from the computer 12 to computer transceiver 20. Accordingly, communication cable 18 can be a fiber-optic cable or an electronic USB cable, ethernet cable, PS2, lightning, firewire, IEEE-1394, RS-232, RS-422, RS-485, or other type of cable such as a parallel cable, or communication cable 18 can be dispensed with if computer transceiver 20 is integrated into computer 12 or if the communications between computer 12 and computer transceiver 20 are wireless.

Computer transceiver 20 is a device that transmits and receives signals to and from handset transceiver 32, under the control of the operating system and/or the software executing the file encryption and decryption processes on computer 12, as part of the process for generating secret shared identical symmetric keys at both the computer 12 and handset 30. One exemplary system and method for generating these secret keys at the two devices is disclosed in U.S. Pat. No. 8,320,562, which is herein incorporated by reference in its entirety, although other methods and processes for generating secret keys simultaneously at two or more devices based on motion of at least one of the devices is possible and can be used in other examples as well. The signals 34 transmitted and received by computer transceiver 20 can be optical, such as light or infrared light, radio, or even acoustic by way of example. In this example, the signals 34 generally are analog in nature and contain minimal or preferably no digital information about the key generation process. However, once a secure channel between computer 12 and handset 30 is established then encrypted digital data may be transmitted to and from computer 12 and handset 30 through the signaling medium wherein the encrypted digital data is encrypted with the generated shared secret key.

Handset 30 is a portable or mobile device having a user interface such as a display and a port to which a handset transceiver 32 can be coupled. Handset 30 also has an operating system and application software used for executing its side of the file encryption and decryption processes, and for identifying and selecting computer files and/or encryption keys through its user interface. Handset 30 also has internal non-volatile memory which can used for the long-term storage of one or more file decryption keys, wherein the keys are securely stored for safe-keeping until needed for decrypting an encrypted file on computer 12. In this example, handset 30 is a cell-phone, such as the iPhone series of smart-phones produced by Apple, Inc. by way of example, although other computing devices may be used.

Handset transceiver 32 is a transceiver very similar to computer transceiver 20 except handset transceiver 32 is coupled to, or even integrated into, handset 30. Handset transceiver 32 is a device that transmits and receives signals to and from computer transceiver 20, under the control of the operating system and/or the software executing the file encryption and decryption processes on handset 30, as part of the process for generating secret shared identical symmetric keys at both the computer 12 and handset 30. One exemplary system and method for generating these secret keys at the two devices is disclosed in U.S. Pat. No. 8,320,562, although other methods for generating secret keys simultaneously at two or more devices based on motion of at least one of the devices may be utilized as well. The signals 34 transmitted and received by handset transceiver 32 can be optical, such as light or infrared light, radio, or even acoustic by way of example. The signals 34 generally are analog in nature and contain minimal or preferably no digital information about the key generation process. However, once a secure channel between handset 30 and computer 12 is established then encrypted digital data may be transmitted to and from computer 12 and handset 30 through the handset transceiver 32 and signaling medium wherein the encrypted digital data is encrypted with the generated shared secret key.

Examples of this technology may also be embodied as one or more non-transitory computer readable media having instructions stored thereon for one or more aspects of the present technology as described and illustrated by way of the examples herein. The instructions in some examples include executable code that, when executed by one or more processors, cause the processor(s) to carry out steps necessary to implement the methods of the examples of this technology that are described and illustrated.

An exemplary process for encrypting a computer file will be described with reference to the flowchart of FIG. 2. As seen in FIG. 2, the exemplary encryption process begins at step 100 at which point execution proceeds to step 102.

In step 102, the relevant encryption programs or apps are called up on handset 30 and computer 12 which then prompt the user to swipe or wave the handset 30 with handset transceiver 32 in the air past computer transceiver 20 at which point both the computer 20 and handset 30 measure the shared time-varying gap between the two devices by way of signal 34 and process the time-varying gap measurements to produce a set of identical symmetric shared secret keys at handset 30 and computer 12. The generation of the identical symmetric shared secret keys at handset 30 and computer 12 can be made in accordance with the methods taught in U.S. Pat. No. 8,320,562, although other methods for generating secret keys simultaneously at two or more devices based on motion of at least one of the devices may be utilized as well. Note that once both devices possess these (or other) shared identical secret keys, these keys can be used to encrypt and decrypt data sent between the devices through, for example, the internet or preferably through digital modulation of signal 34, such that the devices can communicate securely with one another.

Next in step 104 the user identifies and selects the one or more computer files that are to be encrypted from a list of computer files 40 presented by the operating system and the encryption program on monitor 14, although other manners for obtaining the file or files can be used.

Once the computer file or files are selected, execution proceeds to step 106 in which the selected file or files are each individually encrypted by the encryption program running on computer 12 with the encryption key generated in step 102.

Then, in step 108, when the desired file or files are each encrypted, any clear-text copies or versions of the encrypted computer file or files can then be optionally, but preferably in tis example, deleted from all memory residing within computer 12. Additionally, all remaining vestiges of the deleted clear-text file or files can be further wiped from memory by further executing overwriting of their former locations within memory with new data; optionally, the overwriting process can be repeated several times, such as five or more, to completely remove any remaining trace of the clear-text data. Further, within computer 12, any and all copies of the key generated in step 102 can be deleted from memory, and all remaining vestiges of the deleted key can be further wiped from memory by executing overwriting of its former location(s) within memory with new data; optionally, the overwriting process can be repeated several times, such as five or more, to completely remove any remaining trace of the key.

Next in step 110 at the handset 30 the secret key generated in step 102 is stored in long term non-volatile memory by the user under the control of the operating system and the software executing the file encryption process on handset 30. Additionally, the software executing the file encryption process on handset 30 may prompt the user for the name, or other notes or identifying nomenclature, of the computer file that the stored encryption key is associated with to facilitate the later decryption of the computer file with the stored encryption key. This last activity can be the last process step of the file encryption process, after which execution proceeds to process step 114 at which time the encryption process completes and terminates.

At this juncture the encrypted file(s) reside on the computer 12 and the key required to decrypt the encrypted file(s) on the computer 12 reside only on the handset 30. Even if a malicious actor were to steal the encrypted file(s) on the computer 12, they would not be able to obtain useful data from the stolen files unless they also had the decryption key on the handset 30. In other words, the malicious actor would have to steal both the encrypted file from the computer 12 and the decryption key from the handset 30—a highly unlikely chain of events—in order to open and obtain data from the encrypted computer file.

An exemplary process for decrypting a computer file that was encrypted with exemplary methods taught in this disclosure, particularly with the methods described in connection with FIG. 2, will now be described with reference to the flowchart of FIG. 3. As seen in FIG. 3, the exemplary decryption process begins when the process starts at step 120 at which point execution proceeds to step 122.

In step 122, the relevant decryption programs or apps are called up on handset 30 and computer 12 which then prompt the user to swipe or wave the handset 30 with handset transceiver 32 in the air past computer transceiver 20 at which point both the computer 20 and handset 30 measure the shared time-varying gap between the two devices by way of signal 34 and process the time-varying gap measurements to produce a set of identical symmetric shared secret keys at handset 30 and computer 12. The generation of the identical symmetric shared secret keys at handset 30 and computer 12 can again be made in accordance with the methods taught in U.S. Pat. No. 8,320,562, although other methods for generating secret keys simultaneously at two or more devices based on motion of at least one of the devices may be utilized as well.

Next in step 124 the user identifies and selects the computer file or files that are to be decrypted from a list of computer files 40 presented by the operating system and/or the encryption program on monitor 14.

Once the computer file or files are selected, execution proceeds to step 126 in which the encryption key generated in step 102—which is now the decryption key for the computer file and will hereinafter be identified as such—and which is saved in non-volatile memory within handset 30 in this example is encrypted with the key generated in step 122.

Execution then proceeds to step 128 and the encrypted decryption key is transmitted to computer 12; the transmission can occur by way of a modulated signal 34 emitted by handset transceiver 32 and received by computer transceiver 20, or the transmission can be through an unsecure medium, such as the internet or even twisted-pair wires by way of example only, since the information being transmitted is encrypted and secured with the key generated in step 122.

After the computer 12 receives the encrypted decryption key in step 130, the computer decrypts the decryption key with its copy of the secret key that was also identically generated in step 122. The software running within computer 12 now has possession of the key needed to decrypt the file identified and selected in step 124 and in step 132 the file identified and selected in step 124 is decrypted with that key. Finally in step 134 the keys generated in step 122, as well as the key generated in step 102 and saved in the handset's 30 non-volatile memory, are deleted whereafter execution proceeds to step 136 and the decryption process terminates. At this juncture a fully decrypted clear-text version of the identified and selected file or files now resides on computer 12.

One exemplary variation of the system and method described above for securing a computer file entails replacing a portable or moveable handset 30 with a second computer which is not normally moveable, but has a swipe-able, wave-able, or otherwise movable transceiver, like computer transceiver 20, that can be used to generate secret keys in process steps 102 and 122. The second computer is coupled to its accompanying transceiver with a flexible cable or other wireless coupling in other examples to facilitate the movement of its transceiver relative to computer transceiver 20 during the key generation process. Alternately computer transceiver 20, being coupled to computer 12 through its own communication cable 18, which can itself be flexible, or other wireless coupling in other examples allows for computer transceiver 20 to be swipe-able, wave-able, or otherwise movable to facilitate the secret key generation process in steps 102 and 122.

A second exemplary variation on the system and method described above for securing a computer file entails generating a second set of secret keys during the process of encrypting the computer file which are used for securing communications between handset 30 and computer 12. In particular, in process step 102 the user can swipe, wave, or move the handset 30 with handset transceiver 32 in the air past computer transceiver 20 a second time in which both the computer 12 and handset 30 measure the shared time-varying gap between the two devices by way of signal 34 and process the time-varying gap measurements to produce a second set of identical symmetric shared secret keys at handset 30 and computer 12. The generation of the second set identical symmetric shared secret keys at handset 30 and computer 12 can be made in accordance with the methods taught in U.S. Pat. No. 8,320,562 or through other methods that are used to encrypt and decrypt digital messages communicated between handset 30 and computer 12.

A third exemplary variation on the system and method described above for securing a computer file entails swapping the roles of the mobile handset 30 device and the computer device 12 such that at the end of the file encryption process the encrypted file(s) reside only on handset 30 device and the decryption key for the encrypted file(s) on the handset device 30 reside only on computer 12. During file decryption then, the decryption key on the computer 12 is encrypted and transmitted to the handset 30 which decrypts the key and uses the decrypted key to decrypt the encrypted file(s) in its possession.

It is important to note that the system and method for securing a computer file, and the variations described herein, do not rely upon solving a so-called one-way math problem common to most public-private key cryptographic methods which are expected to be susceptible to breaking by quantum computers in the near future. Accordingly, the prescribed system and method for securing a computer file, and the variations described herein, are not susceptible to being broke by quantum computers when they become available.

It is also important to note that the system and method for securing a computer file, and the variations described herein, do not rely upon the use of the internet for its operation. This is highly beneficial and improves the robustness of the prescribed system and methods as the internet is a notoriously insecure communication medium.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for securing a file on a computing device, the method comprising:
generating, by the computing device, an encryption key at the computing device having a file based on obtained movement data of at least one of the computing device with the respect to another computing device, wherein the another computing device has the encryption key separately generated based on the obtained movement data and the encryption key at the computing device and the another computing device is substantially the same;
encrypting, by the computing device, the file on the computing device with the encryption key; and
discarding, by the computing device, the encryption key at the computing device with the encryption key saved on the another computing device.

2. The method as in claim 1 further comprising:
deleting, by the computing device, any clear-text version of the encrypted file from all memory residing within the computing device once the file is encrypted and transmitted.

3. The method as in claim 1 further comprising:
generating, by the computing device, another encryption key at the device having the encrypted file based on obtained additional movement data of at least the computing device with the respect to the another computing device, wherein the another computing device has the another encryption key separately generated based on the obtained additional movement data and the another encryption key at the computing device and the another computing device is substantially the same;
decrypting, by the computing device, the encryption key received from the another computing device that was encrypted with the another encryption key by the another computing device; and
decrypting, by the computing device, the file with the decrypted encryption key.

4. The method as in claim 3 further comprising:
deleting, by the computing device, the encryption key and the another encryption key on the computing device and on the another computing device.

5. A non-transitory machine readable medium having stored thereon instructions comprising executable code that, when executed by one or more processors, causes the processors to: generate an encryption key at a computing device having a file based on obtained movement data of at least one of the computing device with the respect to another computing device wherein the another computing device has the encryption key separately generated based on the obtained movement data and the encryption key at the computing device and the another computing device is substantially the same;
encrypt the file on the computing device with the encryption key; and
discard the encryption key at the computing device with the encryption key saved on the another computing device.

6. The non-transitory machine readable medium as in claim 5, wherein the executable code, when executed by the processors, further causes the processors to:
delete any clear-text version of the encrypted file from all memory residing within the computing device once the file is encrypted.

7. The non-transitory machine readable medium as in claim 5, wherein the executable code, when executed by the processors, further causes the processors to:
generate another encryption key at the computing device having the encrypted file based on obtained additional movement data of at least one of the computing device with the respect to the another computing device, wherein the another computing device has the another encryption key separately generated based on the obtained additional movement data and the another encryption key at encryption key at the computing device and the another computing device is substantially the same;
decrypt the encryption key received from the another computing device at the computing device that was encrypted with the another encryption key by the another computing device; and
decrypt the file at the computing device with the decrypted encryption key.

8. The non-transitory machine readable medium as in claim 7, wherein the executable code, when executed by the processors, further causes the processors to:
delete the encryption key and the another encryption key on the computing device and on the handset.

9. A system device comprising one or more computing devices each comprising memory having programmed instructions stored thereon and one or more processors configured to execute the stored programmed instructions to:
generate an encryption key at a computing device having a file based on obtained movement data of at least one of the computing device with the respect to the another computing device wherein the another computing device has the encryption key separately generated based on the obtained movement data and the encryption key at the computing device and the another computing device is substantially the same;
encrypt the file on the computing device with the encryption key; and
discard the encryption key at the computing device with the encryption key saved on the another computing device.

10. The system as in claim 9, wherein the processors are further configured to execute the stored programmed instructions to:
delete any clear-text version of the encrypted file from all memory residing within the computing device once the file is encrypted.

11. The system as in claim 9, wherein the processors are further configured to execute the stored programmed instructions to:
generate another encryption key at the computing device having the encrypted file based on obtained additional movement data of at least one of the computing device with the respect to the another computing device, wherein the another computing device has the another encryption key separately generated based on the obtained additional movement data and the another encryption key at each of the computing device and the another computing device is substantially the same;
decrypt the encryption key received from the another computing device at the computing device that was encrypted with the another encryption key by the another computing device; and
decrypt the file at the computing device with the decrypted encryption key.

12. The system as in claim 11, wherein the processors are further configured to execute the stored programmed instructions to:
delete the encryption key and the another encryption key on the computing device and on the handset.
